(19) United States
(12) Patent Application Publication
(10) Pub. No.: US 2012/0183871 A1
(43) Pub. Date: Jul. 19, 2012

(54) METHOD OF OPERATING HIGH TEMPERATURE FUEL CELL

(75) Inventors: Tae-young KIM, Seoul (KR); Jung-ock Park, Yongin-si (KR); Suk-gi Hong, Seongnam-si (KR); Tae-won Song, Yongin-si (KR); Ji-rae Kim, Seoul (KR)

(73) Assignee: Samsung Electronics Co., Ltd., Suwon-si (KR)

(21) Appl. No.: 13/172,049

(22) Filed: Jun. 29, 2011

(30) Foreign Application Priority Data
Jan. 13, 2011 (KR) 10-2011-0003552

(51) Int. Cl. H01M 8/04

(52) U.S. Cl. 429/429

(57) ABSTRACT

A method of operating a high-temperature fuel cell, the method including increasing the temperature of a fuel cell stack the operation of which has stopped; starting the operation of the fuel cell stack and applying at least a portion of a load to the fuel cell stack when the temperature of the fuel cell stack reaches a first temperature; and applying any remaining load to the fuel cell stack when the temperature of the fuel cell stack reaches a second temperature that is higher than the first temperature.

### CROSS-REFERENCE TO RELATED APPLICATIONS

This application claims the benefit of Korean Patent Application No. 10-2011-0003552, filed on Jan. 13, 2011, in the Korean Intellectual Property Office, the disclosure of which is incorporated herein in its entirety by reference.

### BACKGROUND OF THE INVENTION

1. Field

The present disclosure relates to fuel cells, and more particularly, to methods of operating high temperature fuel cells.

2. Description of the Related Art

Polymer electrolyte membrane fuel cells (PEMFC) that operate at high temperatures, for example, 100° C. or higher, have several advantages over fuel cells that operate at low temperatures. AA PEMFC that operates at high temperatures (hereinafter, referred to as a high-temperature PEMFC) operates in a non-humid environment, and thus a humidifier is not necessary for the high-temperature PEMFC to operate. Thus, the high-temperature PEMFC is easily operated in terms of, for example, water control, and has high reliability. In addition, since the high-temperature PEMFC does not require a humidifier and operates at high temperatures, a fuel electrode included in the high-temperature PEMFC has high resistance to carbon monoxide (CO) poisoning. Accordingly, the fuel reformer may be simplified and the costs for a balance-of-plant (BOP) may be lowered when using the high-temperature PEMFC.

A high-temperature PEMFC includes a membrane electrode assembly (MEA), such as a phosphoric acid-doped MEA. A high-temperature PEMFC including a phosphoric acid-doped MEA operates at a temperature of 150° C. to 200° C. The operation startup time of a high- temperature PEMFC is longer than that of a low-temperature PEMFC that normally operates at a temperature of 80° C. A low-temperature PEMFC immediately starts operating at room temperature, and after the low-temperature PEMFC has started operating, the low-temperature PEMFC reaches a normal operation temperature due to reaction heat generated by the electrochemical reaction in the MEA . However, a phosphoric acid-doped MEA , functioning as a hydrogen ion conductor, has low conductivity at room temperature. Accordingly, if a low-temperature PEMFC includes an acid-doped MEA, in order to apply a load to the low-temperature PEMFC, the temperature of the low-temperature PEMFC needs to be increased.

A high-temperature PEMFC is available for use in a household fuel cell. However, when a high-temperature PEMFC operates in a daily start and stop (DSS) mode, in which starting and stopping are repeatedly performed, the performance of the high-temperature PEMFC needs to be maintained at a normal level.

The performance of a phosphoric acid-doped MEA in high-temperature PEMFCs may differ according to the degree of distribution of phosphoric acid as an ion conductor in an electrode and on the amount of the phosphoric acid distributed in the electrode. During the operation of a high-temperature PEMFC, the fuel-cell temperature, fuel-cell humidity, and concentration of the phosphoric acid change according to on and off operations. If the phosphoric acid leaks from the MEA, the amount of phosphoric acid in the high-temperature PEMFC is reduced and thus performance of the fuel cell is compromised.

The leakage of phosphoric acid may be more serious when the high-temperature PEMFC operates in the DSS mode than in a consecutive operation mode.

### SUMMARY OF THE INVENTION

Embodiments of the invention relate to methods of operating high temperature fuel cells.

Additional aspects and/or advantages of the invention will be set forth in part in the description which follows and, in part, will be obvious from the description, or may be learned through practice of the invention by those skilled in the art.

According to an aspect of the invention, a method of operating a high temperature fuel cell comprises: increasing the temperature of the fuel cell stack, the operation of which has been stopped; starting the operation of the fuel cell stack and applying a portion of a load to the fuel cell stack when the temperature of the fuel cell stack reaches a first temperature; and applying any remaining load to the fuel cell stack when the temperature of the fuel cell stack reaches a second temperature that is higher than the first temperature.

The first temperature may be lower than a normal operation temperature of the fuel cell stack. The first temperature may be higher than 60° C. and lower than the normal operation temperature of the fuel cell stack.

The load may be completely applied to the fuel cell stack for, at most, one hour.

The application of the portion of the load to the fuel cell stack may comprise dividing the load into at least two portions so as to apply the load portions in phases.

The application of any remaining load to the fuel cell stack may comprise dividing the load into at least two portions so as to apply the load portions in phases. In this regard, in each phase, the cell potential of the fuel cell stack may be maintained at 0.8 V or less.

Increasing the temperature of the fuel cell stack may be performed by allowing cooling water that has been heated or gas whose temperature has been increased to contact the fuel cell stack, using an external heating device disposed outside the fuel cell stack, or using a heat dissipating catalyst or a separate plate to internally heat the fuel cell stack.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart illustrating a method of operating a high-temperature fuel cell according to an embodiment of the present invention;

FIG. 2 is a graph for explaining a case in which a load is divided into portions and the portions are applied in phases before the temperature of the high-temperature fuel cell reaches a normal operation temperature in an example of a method of operating a high-temperature fuel cell according to an embodiment of the invention;

FIG. 3 is a graph for explaining a case in which a load is completely applied at one time when the temperature of the high-temperature fuel cell reaches a normal operation temperature in another example of a method of operating a high-temperature fuel cell according to an embodiment of the invention for comparison with the example of FIG. 2;

FIG. 4 shows voltage characteristics of first and second membrane and electrode assemblies (MEAs) when the first and second MEAs are operated in a daily start and stop (DSS) mode in an example of a method of operating a high-temperature fuel cell according to an embodiment of the invention;

FIG. 5 is a graph of temperature over time and an amount of an applied load when a third MEA is operated in a reference operation starting mode and a low-temperature starting mode in another example of a method of operating a high-temperature fuel cell according to another embodiment of the invention; and

FIG. 6 is a graph of voltage of a third MEA when the third MEA is operated in a normal operation condition in another example of a method of operating a high-temperature fuel cell according to another embodiment of the invention.

### DETAILED DESCRIPTION OF THE INVENTION

Reference will now be made in detail to embodiments of the invention, examples of which are illustrated in the accompanying drawings, wherein like reference numerals refer to like elements throughout. In this regard, the embodiments may have different forms and should not be construed as being limited to the descriptions set forth herein. Accordingly, the embodiments are described below in order to explain the invention by referring to the figures.

Hereinafter, a method of operating a high-temperature fuel cell will be described in detail with reference to the drawings in which thicknesses of layers and regions are enlarged for clarity

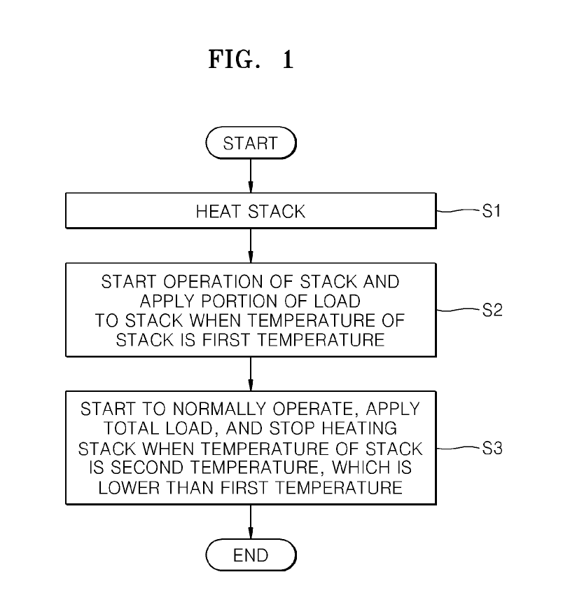

FIG. 1 is a flowchart illustrating a method of operating a high-temperature fuel cell, for example, a high-temperature polymer electrolyte membrane fuel cell (PEMFC), according to an embodiment of the invention.

Referring to FIG. 1, the method comprises heating a fuel cell stack including a membrane electrode assembly (MEA) (operation S1). The fuel cell stack may be heated by using any of various methods. For example, the fuel cell stack may be heated by allowing cooling water that has been heated or a supply gas, for example, air or a fuel, whose temperature has been increased to contact the fuel cell stack, using an external heating device, for example, a heater or a burner, or using a heat dissipating catalyst or a separate plate to internally heat the fuel cell stack. Then, after beginning the heating of the fuel cell stack, when the temperature of the fuel cell stack reaches a first temperature, a fuel gas is supplied to the fuel cell stack in order for the fuel cell stack to start operating (operation S2). The first temperature may be higher than about 60° C. and lower than a normal operation temperature thereof. For example, the first temperature may be equal to or higher than 70° C., for example, 145°. When operation S2 starts, a load is applied to the fuel cell stack in divided portions. The load portions are applied in phases at time intervals until the temperature of the fuel cell stack reaches the normal operation temperature thereof. For example, a load is divided into two or more portions and then the load portions are sequentially applied. In this case, an amount of the load that is applied in the initial phase may be such an amount that the potential of each of the cells of the fuel cell stack, for example, is equal to or lower than 0.8 V. The amount of the load applied in the first phase may be, for example, 10% of the total amount of the load. The load portions may each be applied for the same time period, or for different time periods depending upon the amounts of the load portions applied. For example, the smaller the amount of the load, the longer the time period in which the amount is applied to the fuel cell stack. On the other hand, when the temperature of the fuel cell stack is near its normal operation temperature, the greater the amount of the load, the shorter the time period in which the amount is applied to the fuel cell stack. The total time period for applying the total amount of the load may be, for example, less than 1 hour, less than 40 minutes, or less than 20 minutes.

The method includes, when the temperature of the fuel cell stack reaches the second temperature, starting a normal operation of the fuel cell stack, applying any remaining amount of the load, and stopping the heating of the fuel cell stack (operation S3). The second temperature is the normal operation temperature of the fuel cell stack. The second temperature is higher than the first temperature. The second temperature may be, for example, from about 150° C. to about 160° C. If operation S3 is performed for a given time period, the operation of the fuel cell stack may stop. After the operation of the fuel cell stack stops, the fuel cell stack may then be subjected to operations S1 through S3 again. The starting and stopping of the operation of the fuel cell stack may be repeatedly performed, and the starting time and the stopping time of the fuel cell stack may differ depending upon the condition/environment in which the fuel cell stack is used or the purpose for which the fuel cell stack is used.

Hereinafter, an example of the method as described above will be described in detail.

In the present example, two MEAs are used. One (hereinafter referred to as the first MEA) is used to verify the operation method according to an embodiment of the invention, and the other (hereinafter referred to as the second MEA) is used as a comparative example.

The first and second MEAs have the same structure and are formed of the same materials, and are manufactured by using the same method. Hereinafter, a method of manufacturing the first and second MEAs will be described in detail.

A cathode is manufactured as follows. PtCo/C (Pt 46.5%) as a carbon supported catalyst, PVdF (5 w % solution in N-methyl-2-pyrrolidone (NMP) as an organic binder, and an NMP solvent are mixed. A ratio of the components is controlled such that with reference to a solid content remaining after drying, the amount of PVdF is 2.5%. Then, the mixture is stirred by using a mixer to prepare a slurry, and the slurry is coated on carbon paper SGL35BC. After the coating with the slurry, drying is performed using a hot plate at a temperature of about 60° for at least one hour. Then, drying is performed using an oven at a temperature of about 80° C. for about 1 hour, at a temperature of 120° C. for 30 minutes, and then at a temperature of 150° C. for 10 minutes, thereby completing manufacturing of the cathode. A membrane to be included in the MEA is prepared by impregnating a polyphenyleno oxide (PPO) film with a phosphoric acid at a temperature of 80° for 5 hours.

An anode is manufactured in the same manner as described above with reference to the cathode, except that PtRu/C is used as the carbon-supported catalyst.

The cathode, the membrane, and the anode are sequentially stacked and then, the stacked structure is placed in a test cell and sealed with a torque of about 3 Nm, thereby manufacturing an MEA. In this case, the reaction area of the MEA is set to be 7.84 cm², which is smaller than its actual reaction area. A reaction area that is smaller than an actual reaction area is easily used to perform a verification test. Since unique operation characteristics of the MEA, for example, leakage of a phosphoric acid, are independent from the reaction area of the MEA, test results may also be applied to a fuel cell having an actual reaction area.

The first and second MEAs manufactured as described above are operated as follows, and performance changes of the first and second MEAs are compared to each other in a normal operation state (for example, an MEA temperature is 150° C. and a constant current density of 0.2 A/cm² is generated).

A test cell including each of the first and second MEAs is connected to a fuel cell test device and is operated in a normal operation state (for example, an MEA temperature is 150° and a constant current density of 0.2 A/cm², corresponding to 100% of a load, is generated) for one week while air is supplied to the cathodes of the MEAs and hydrogen is supplied to the anodes of the MEAs, thereby activating the MEAs.

After the activation, operating and stopping of the MEAs are alternately performed. For example, the MEAs are operated in a daily start and stop (DSS) mode.

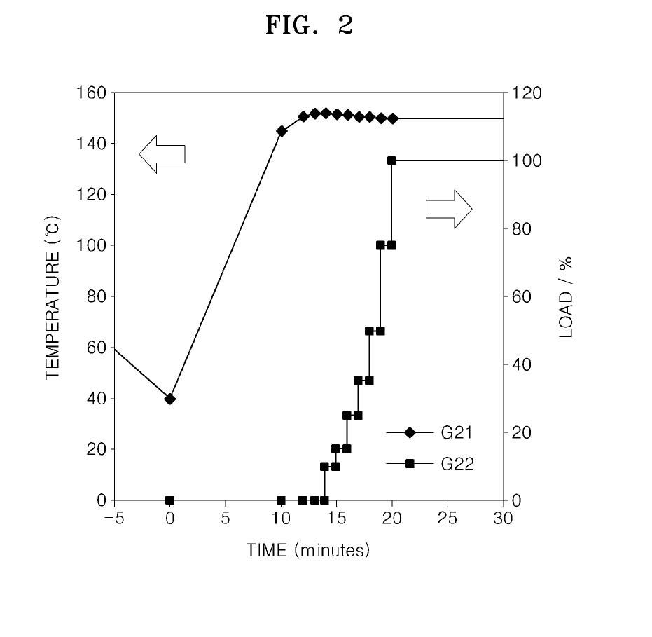

In detail, the first MEA is operated in the normal operation state for 3 hours, and then the operation of the first MEA is stopped. In this case, both electrodes of the first MEA are shorted in order to remove any effect derived from the stopping conditions. Then, when the temperature of the first MEA reaches 40° C., the temperature of the first MEA is increased by heating the first MEA using any one of the heating methods described above, or another heating method. If the temperature of the first MEA is lower than a normal operating temperature of the first MEA in the normal operation state, for example, 145° C., a fuel gas, for example, a hydrogen gas or a hydrogen-containing gas is supplied to the first MEA and a load is applied to the first MEA. In this case, the load is applied by using the method illustrated in FIG. 2.

In FIG. 2, the x axis and the y axis respectively indicate time (minutes) and temperature (° C.). Also, in FIG. 2, the first plot (G21) is of the temperature of the first MEA over time, and the second plot (G22) is of the amount of the load applied in phases until the temperature of the first MEA reaches the normal operation temperature.

Referring to FIG. 2, the load is divided into seven portions and the portions are applied to the first MEA at time intervals. In a first phase, a portion of the total load, for example, 10%, is applied to the first MEA. The first phase for applying the load may be performed when the temperature of the first MEA is lower than the normal operation temperature, for example, 145° C. However, the first phase may also be performed when the temperature of the first MEA is higher than 145° C. In a last phase for applying the load, the temperature of the first MEA becomes the normal operation temperature. In the last phase for applying the load, the load amount therein is any remaining load amount of the load after portions of the load are applied in the first through sixth phases. The load amount in the last phase is less than 20% of the total load amount. The time period in which the load is completely applied to the first MEA may be less than 20 minutes. Also, each of the seven phases for applying the load is maintained for 2 minutes. In addition, the load amount of the load applied in the initial phase is controlled such that the potential of the first MEA is equal to or less than 0.8 V.

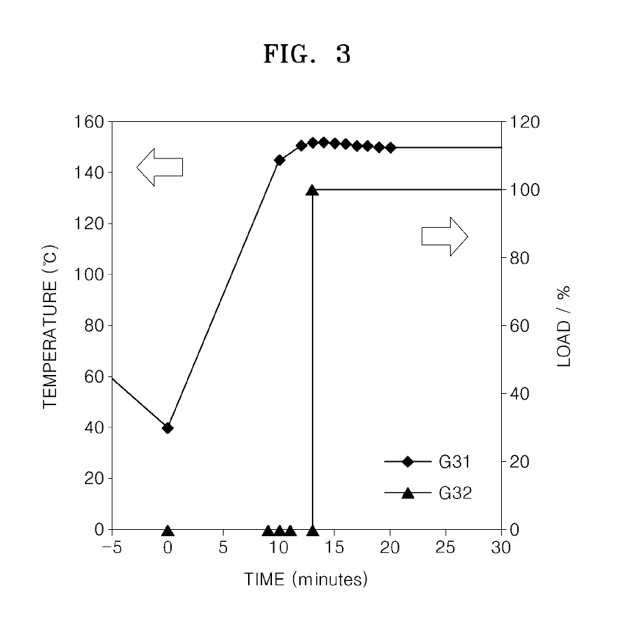

Regarding the second MEA, the same test as described above is performed except for the load applying method. Regarding the second MEA, a load is applied as illustrated in FIG. 3. In FIG. 3, the first plot (G31) is of the temperature of the second MEA over time, and a second plot (G32) is of the amount of the load applied to the second MEA.

Referring to the second plot (G32) of FIG. 3, the total amount of the load is applied to the second MEA at one time when the temperature of the second MEA is 145° C.

If the starting and stopping of the first and second MEAs are repeatedly performed, the results are the same as those when the first and second MEAs are operated in the DSS mode.

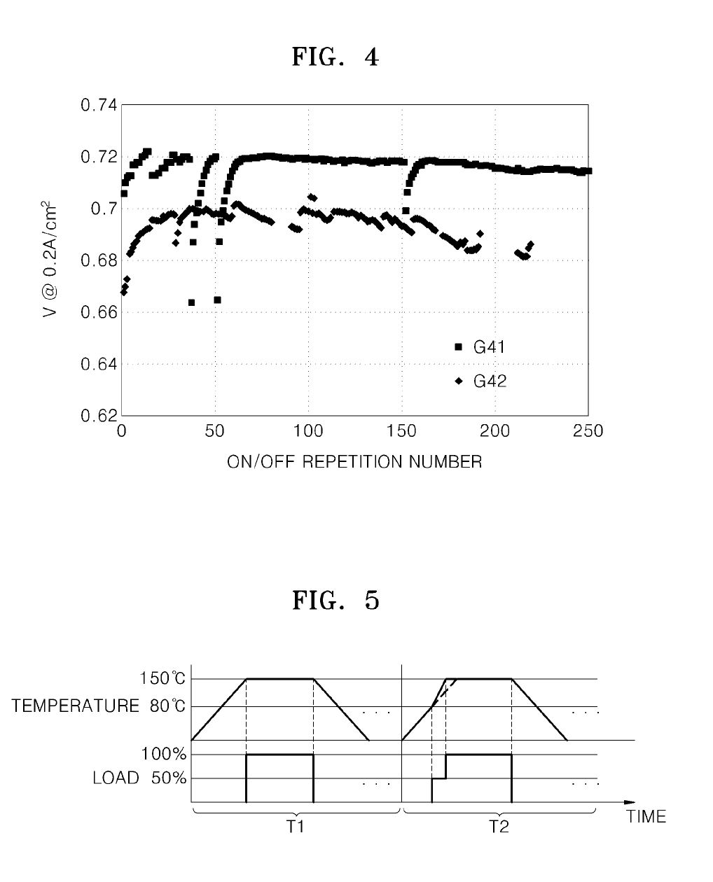

FIG. 4 shows voltage characteristics of the first and second MEAs when the first and second MEAs are operated in the DSS mode. The voltage characteristics illustrated in FIG. 4 are measured in the normal operation state. In FIG. 4, the x axis indicates the number of operation cycles of the first and second MEAs, that is, repetitions of starting and stopping. For example, if the x value is “50,” the starting and the stopping are alternately performed 50 times. In FIG. 4, the y axis indicates voltage measured in the normal operation state.

In FIG. 4, the first plot (G41) is of the first MEA, and the second plot (G42) is of the second MEA.

Referring to the first and second plots G41 and G42 of FIG. 4, it is confirmed that a voltage decrease rate of the first MEA is much lower than that of the second MEA. A voltage decrease value of the first MEA per cycle is 35 μV, and a voltage decrease of the second MEA per cycle is 71.9 μV. That is, the voltage decrease rate of the second MEA is higher than the voltage decrease rate of the first MEA.

FIG. 4 shows that if, when an operation of a MEA is stopped and then started, the MEA starts its operation before a temperature of the MEA reaches a normal operation temperature and a load is applied to the MEA in such a way that the load is divided into portions and the load portions are applied in phases, better voltage decrease characteristics may be obtained than when a conventional operation method is used.

If phosphoric acid leaks from the MEA, voltage decrease characteristics of the MEA may be degraded. In the present example, the first and second MEAs have the same structure and are formed of the same materials, and are operated using different operation methods.

In this respect, the results shown in FIG. 4 indicate that when a high-temperature fuel cell is operated by using a method according to an embodiment of the invention, phosphoric acid leaks less or is prevented altogether than when a high-temperature fuel cell is operated by using a conventional method.

Hereinafter, another example of the method described with reference to FIG. 1 will be described in detail.

In the present example, an MEA starts its operation at a temperature lower than that in the previous example and a portion of a load is applied to the MEA.

The MEA (hereinafter, referred to as a third MEA) has the same structure and is formed of the same materials as the first and second MEAs. The difference between the first and second MEAs and the third MEA lies in the reaction area. That is, the reaction area of the third MEA is greater than those of the first and second MEAs and is equivalent to an actual area of a fuel cell stack. One of the reasons the third MEA has such a large reaction area is to identify a low-temperature operation starting effect of the third MEA. The reaction area of the third MEA is 120 cm².

In this example, the third MEA is operated as follows.

The third MEA is activated in the same manner as in the previous example.

After the activation, the third MEA is operated in the DSS mode. That is, starting and stopping of the third MEA are alternately performed. In this case, during the initial 30 cycles, the third MEA is started in a reference operation starting mode, and during the following 30 cycles, the third MEA is started in a low-temperature operation starting mode. The starting and stopping of the third MEA are alternately performed in this way for each mode until the number of cycles is 270.

FIG. 5 is a graph of temperature over time and the amount of an applied load when the third MEA is operated in the reference operation starting mode and the low-temperature starting mode.

In FIG. 5, the x axis indicates time, and the y axis indicates amount of a load (%) and temperature of the third MEA ( ). The first hour (T1) in the x axis refers to the time period during which the starting of the third MEA is repeatedly performed in the reference operation starting mode, and the second hour (T2) in the x axis refers to the time period during which the starting of the third MEA is repeatedly performed in the low-temperature operation starting mode. In the reference operation starting mode continued for the first hour (T1), a load is not applied to the third MEA until the temperature of the third MEA reaches a normal operation temperature of the third MEA, that is, 150° C., and when the temperature of the third MEA reaches the normal operation temperature, the total load is applied to the third MEA at one time, together with a supply of a fuel gas.

On the other hand, in the low-temperature operation starting mode continued for the second hour (T2), a fuel gas is supplied to the third MEA and the third MEA starts its operation when the temperature of the third MEA reaches 80° C.; that is, a temperature lower than the normal operating temperature. Together with the supply of the fuel gas, a portion of the total load, for example, about 50% of the total load is applied to the third MEA. The remaining portion of the total load is applied to the third MEA when the temperature of the third MEA reaches the normal operation temperature. In the low-temperature operation starting mode, the supply of the fuel gas and the application of a portion of the load may start when the temperature of the third MEA is higher than 60° C.

In the low-temperature operation starting mode as described above, as illustrated in FIG. 5, when a portion of the load is applied to the third MEA before the third MEA operates normally, the temperature of the third MEA is relatively quickly increased. As a result, the temperature of the third MEA may reach the normal operation temperature more quickly in the low-temperature operation starting mode than in the reference operation starting mode. Thus, the operation starting time may be shortened.

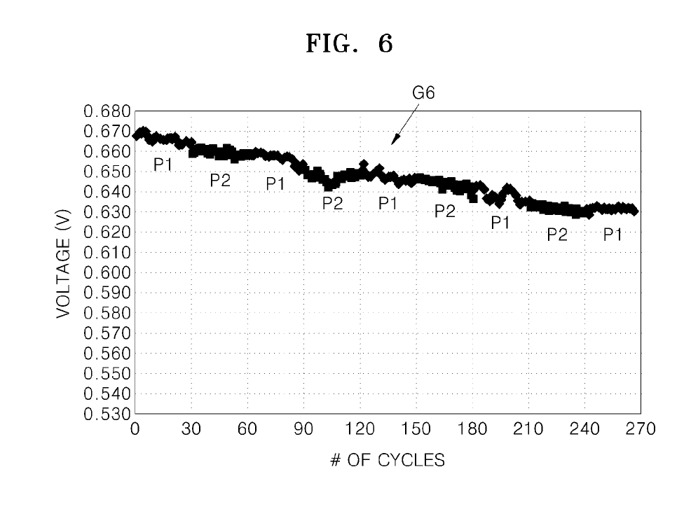

FIG. 6 is a graph of voltage of the third MEA when the third MEA is operated in a normal operation state in this example.

In FIG. 6, the x axis indicates the number of cycles of the third MEA, that is, repetitions of starting and stopping, and the y axis indicates voltage of the third MEA measured in the normal operation state in each cycle. In FIG. 6, the first plot (G6) is of a voltage of the third MEA in the normal operation state with respect to the number of cycles. In the first plot (G6), sections (P2) (hereinafter referred to as sections 2) corresponding to cycle number ranges of 30 to 60, 90 to 120, 150 to 180, and 210 to 240, indicate the voltage of the third MEA when the third MEA is operated in the low-temperature operation starting mode, and the other sections (P1) (hereinafter referred to as sections 1) indicate the voltage of the third MEA when the third MEA is operated in the reference operation starting mode.

Referring to FIG. 6, the first plot (G6) has a negative gradient, which is due to the fact that the third MEA has lower voltages with respect to higher numbers of cycles. In the first plot (G6), the sections 1 and 2 (P1 and P2) change continuously and the sections are continuously connected to form the first plot (G6). The sections 1 and 2 have the same gradient as the first plot (G6). Accordingly, the results shown in FIG. 6 show that even when the third MEA is operated in the low-temperature operation starting mode, performance of the third MEA may not be reduced.

Meanwhile, in consideration of the gradient of the sections 1 and 2 (P1, P2) of FIG. 6, when the third MEA is operated in the reference operation starting mode, the voltage decrease per cycle is 0.285 mV, and when the third MEA is operated in the low-temperature operation starting mode, the voltage decrease per cycle is 0.276 mV.

In the present example, the third MEA has the same structure and is formed of the same materials as the first and second MEAs, and is operated using a different operation method. Accordingly, the fact that a voltage decrease per cycle when the third MEA is operated in the low-temperature operation starting mode is smaller than the voltage decrease per cycle when the third MEA is operated in the reference operation starting mode, indicates that phosphoric acid leaks less when the third MEA is operated in the low-temperature operation starting mode than when the third MEA is operated in the reference operation starting mode.

As described above, in a method of operating a high-temperature fuel cell according to the one or more of the above embodiments of the invention, when the high-temperature fuel cell starts its operation, a load is applied to the high-temperature fuel cell before a temperature of the high-temperature fuel cell reaches a normal operating temperature. In this case, the load may be divided into portions and the load portions are applied to the high-temperature fuel cell at time intervals in phases. By using this method, deterioration of a cell due to leakage of phosphoric acid occurring when a fuel cell operates may be reduced, and additionally, the operation starting time of a fuel cell may also be reduced.

It should be understood that the exemplary embodiments described herein should be considered in a descriptive sense only and not for purposes of limitation. Descriptions of features or aspects within each embodiment should typically be considered as available for other similar features or aspects in other embodiments.

Although a few embodiments of the present invention have been shown and described, it will be appreciated by those skilled in the art that changes may be made in this embodiment without departing from the principles and spirit of the invention, the scope of which is defined in the claims and their equivalents.

What is claimed is:

1. A method of operating a fuel cell, the method comprising:
increasing the temperature of a fuel cell stack at which the operation thereof stops;
starting the operation of the fuel cell stack and applying at least a portion of a load to the fuel cell stack until the temperature of the fuel cell stack reaches a first temperature; and
applying any remaining load to the fuel cell stack when the temperature of the fuel cell stack reaches a second temperature that is higher than said first temperature.

2. The method of claim 1, wherein the first temperature is lower than a normal operation temperature of the fuel cell stack.

3. The method of claim 1, wherein the first temperature is higher than 60° C. and lower than a normal operation temperature of the fuel cell stack.

4. The method of claim 1, wherein the load is completely applied to the fuel cell stack for at most one hour.

5. The method of claim 1, wherein any application of a portion of the load to the fuel cell stack comprises dividing the load into at least two portions and applying the load portions in phases.

6. The method of claim 5, wherein during the division of the load into at least two portions to be applied in phases, the cell potential of the fuel cell stack is maintained at 0.8 V or less.

7. The method of claim 1, wherein the increasing of the temperature of the fuel cell stack comprises:
allowing cooling water that has been heated or a supply gas whose temperature has been increased to contact the fuel cell stack;
heating with an external heating device disposed outside the fuel cell stack; or
using a heat dissipating catalyst or a separate plate to internally heat the fuel cell stack.
